(19) United States
(12) Patent Application Publication
(10) Pub. No.: US 2025/0306794 A1
(43) Pub. Date: Oct. 2, 2025

(54) INTERFACE AND DATA PATH DECOUPLING

(71) Applicant: Micron Technology, Inc., Boise, ID (US)

(72) Inventors: Andrea Sorrentino, München (DE); Marcos Alvarez Gonzalez, München (DE); Morshed Mohammed, Freising (DE); Luiza Souza Correa, München (DE); Wolfgang Anton Spirkl, Germering (DE); Paritosh Piyush Sahu, München (DE); Kevin Gajera, Munich (DE); Natalija Jovanovic, München (DE)

(21) Appl. No.: 19/082,003

(22) Filed: Mar. 17, 2025

Related U.S. Application Data
(60) Provisional application No. 63/571,332, filed on Mar. 28, 2024.

(51) Int. Cl. G06F 3/06

(52) U.S. Cl. CPC G06F 3/0653; G06F 3/0604; G06F 3/0673

(57) ABSTRACT

Methods, systems, and devices for interface and data path decoupling are described. In an operating mode, a data path and an interface of a memory system may execute at a same speed, while in two test modes, the data path may execute at a first speed, while the interface may execute at a second speed that is slower than the first speed. If the memory system receives an indication to enter one of the two test modes, the memory system may slow a data rate over the interface according to the indicated test mode by selecting a first subset or a second subset of encoded data to be transmitted over the interface, where the unselected subset may not be transmitted. To return to the operating mode, the device may be reset or may receive another dedicated signal to enter the operating mode.

### CROSS REFERENCE

The present Application for Patent claims priority to U.S. Patent Application No. 63/571,332 by Sorrentino et al., entitled “INTERFACE AND DATA PATH DECOUPLING,” filed Mar. 28, 2024, which is assigned to the assignee hereof, and which is expressly incorporated by reference in its entirety herein.

### TECHNICAL FIELD

The following relates to one or more systems for memory, including interface and data path decoupling.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports interface and data path decoupling in accordance with examples as disclosed herein.

FIG. 2A shows an example of a timing diagram and FIG. 2B shows an example of a mode configuration table that support interface and data path decoupling in accordance with examples as disclosed herein.

FIG. 3 shows an example of an encoding circuit that supports interface and data path decoupling in accordance with examples as disclosed herein.

FIG. 4 shows a block diagram of a memory system that supports interface and data path decoupling in accordance with examples as disclosed herein.

FIG. 5 shows a flowchart illustrating a method or methods that support interface and data path decoupling in accordance with examples as disclosed herein.

### DETAILED DESCRIPTION

A memory system may include, among other aspects, a data path and an interface. The data path may correspond to one or more internal data paths within a memory device (e.g., between memory blocks) or across multiple memory devices, and the interface may correspond to one or more channels between the memory system and an external device (e.g., a host). The data path, in some systems, may support different data rates (e.g., speeds) than the interface, which may cause one or more test operations to finish prematurely if the data path or the interface fails. Therefore, some systems may be unable to detect a maximum supported data rate for both the interface and the data path, as testing may be limited by a lowest supported data rate of two data rates, each data rate respectively supported by the interface or the data path. Thus, techniques for testing whether a data path, an interface, or both, may run at a higher speed without failing the other may be beneficial.

As described herein, a memory system may support interface and data path decoupling, in which independent data rates may be utilized for the interface and the data path. In one or more operating modes (e.g., operation modes) of the memory system, a data path and an interface may execute at a same speed or at least a similar speed and may support a corresponding data rate. In one or more test modes supported by the memory system and described herein, the data path may perform at a first speed, such as a maximum speed (e.g., full speed), while the interface may perform at a second speed that is different than (e.g., slower than) the first speed, or vice versa. The data path may convey bits of data over multiple parallel lines, such as two parallel lines (e.g., even and odd), where each line of data may be encoded by an encoder into modulated signaling (e.g., phase amplitude modulation (PAM) signaling having three symbols, such as PAM3 signaling).

If the memory system receives an indication (e.g., via a mode register, via signaling) to enter one of two or more supported test modes, the memory system may adjust (e.g., slow) a data rate over the interface according to the indicated test mode. For example, there may be a multiplexer at an output of the encoder that may select a first subset or a second subset of the encoded data to be transmitted over the interface within a given time period based on the test mode, where the unselected subset may not be transmitted over the interface in the time period. As such, at least some (e.g., half) of the data may be conveyed over the interface within the time period, thereby reducing the data rate of the transmission to another data rate (e.g., half of the data rate) so that each symbol may be increase (e.g., double) the width. The increased symbol width may improve an accuracy of strobing by a receiver (e.g., the host) of the data. Additionally, or alternatively, the test mode may support testing of the data path at one or more data rates that may not be supported by the interface, or vice versa. In some examples, the test mode may be set by a controller or via some other signaling from a host or an external device (e.g., by a mode register set (MRS) command). To return to the operating mode, the device may be reset or may receive another dedicated signal to enter the operating mode.

In addition to applicability in memory systems as described herein, techniques for interface and data path decoupling may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by providing for independent testing of a data path and an interface within a device, which may improve testing accuracy and reliability, providing for improved device performance, reduced latency, and higher supported data rates.

In addition to applicability in memory systems described herein, techniques for interface and data path decoupling may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by providing more accurate testing of general device performance to improve device reliability, which may improve a reliability of security and authentication protocols implemented at a device while incurring lower latency costs (e.g., by implementing it at hardware level) in related communications, among other benefits.

Features of the disclosure are illustrated and described in the context of systems and architectures. Features of the disclosure are further illustrated and described in the context of timing diagrams, mode configuration tables, encoding circuits, block diagrams, and flowcharts.

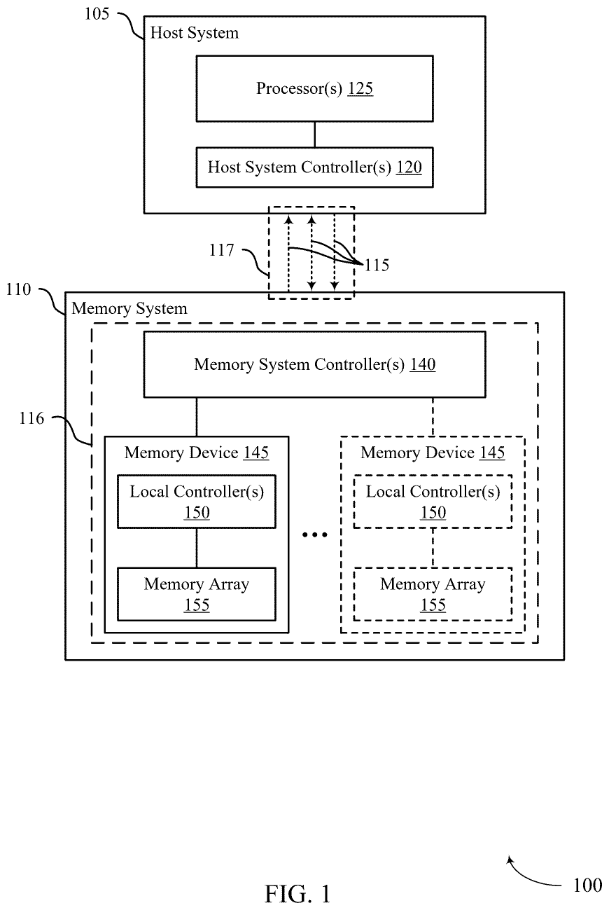

FIG. 1 illustrates an example of a system 100 that supports interface and data path decoupling in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in one or more processors 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in one or more host system controllers 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include one or more memory system controllers 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, one or more local controllers 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include one or more local controllers 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

Signals communicated over the channels 115 may be modulated using various modulation schemes or combinations thereof. A symbol of a binary-symbol (e.g., binary-level) modulation scheme may be operable to represent one bit of data (e.g., a symbol may represent a logic 1 or a logic 0), and may be an example of an M-ary modulation scheme where M is equal to two. Examples of binary-symbol modulation schemes include non-return-to-zero (NRZ), unipolar encoding, bipolar encoding, Manchester encoding, pulse amplitude modulation (PAM) having two symbols (e.g., PAM2), and others. A symbol of a multi-symbol modulation scheme may be operable to represent more than one bit of data (e.g., a symbol may represent a logic 00, a logic 01, a logic 10, or a logic 11), and may be an example of an M-ary modulation scheme where M is greater than or equal to three. For example, a multi-symbol signal may be modulated using a modulation scheme that includes at least three levels to encode more than one bit of information. Multi-symbol modulation schemes and symbols may be referred to as non-binary, multi-bit, or higher-order modulation schemes and symbols. Examples of multi-symbol modulation schemes include PAM3, PAM4, PAM8, and so on, quadrature amplitude modulation (QAM), quadrature phase shift keying (QPSK), and others.

Signaling of the memory system 110 and the host system 105 may also support usage of one or more error correction codes (ECC) and cyclic redundancy check (CRC) bits. CRC bits may be included at the end of a data transmission to protect data bits and may be used to detect bit failures. In some cases, CRC data link protection may be supported for both read and write operations, where data link protection may refer to signaling between the host system 105 and the memory system 110. CRC bits may be computed for each burst transfer on data and may be associated with metadata. During a read operation, the memory system 110 may calculate and send CRC bits on a data signal (e.g., DQ signal) to the host system controller 120 which may calculate the CRC bits on the received data and compare the result to validate the transfer. During writes, the host system 105 may calculate and send CRC bits to the memory system 110 and, together with the write data, the memory system 110 may calculate the CRC bits on the received data and compares it with the received CRC bits to determine if there are one or more errors present due to the transfer. In case of a mismatch, the memory system 110 may return to the host an error flag. In some cases, such CRC operations may be supported by a parallel transfer operation, where one or more CRC bits may be transmitted concurrently on a first line (e.g., even line) and a second line (e.g., odd line), which may each include one or more respective data paths and channels.

In some examples, the memory system 110 may include a data path 116 and an interface 117. For example, the data path 116 may include an internal data path within or across one or more memory devices 145 (e.g., between blocks of one or more memory arrays 155, between one or more memory devices 145 and the memory system controller 140, or any combination thereof). The interface 117 may correspond to the one or more channels 115 between the memory system 110 and the host system 105 (or one or more other channels between the memory system 110 and one or more other external devices). The data path 116 and the interface 117 may support one or more data rates (e.g., speeds) for both SDR and DDR signaling. In some cases, however, different data rates between the data path 116 and interface 117 may result in a failure of one or more operations. For example, in a test operation, the memory system 110 may exchange signaling via the interface 117 with the host system 105 for a write operation, a read operation, or both, involving accessing memory arrays 155 of one or more memory device 145 via the data path 116. The host system 105 may increase a data rate for operations to test a maximum data rate of the interface 117 and the data path 116. However, if the interface 117 supports a lower data rate than the data path 116, the interface 117 may fail (e.g., at a respective maximum data rate) before the data path 116 reaches a maximum data rate for the data path. Thus, the host system 105 and the memory system 110 may be unable to detect a maximum supported data rate for both the interface 117 and the data path 116 concurrently.

As described herein, the memory system 110 may support interface and data path decoupling in which the data path 116 and the interface 117 are independent and support independent data rates and signaling schemes. For example, the memory system 110 may receive an indication of a test mode from the host system 105 (e.g., via the interface 117, via a pin, via a mode register, or via some other indication). The test mode may be associated with operation of the data path 116 at a higher data rate than the data path 116 is operated when the memory system 110 is in an operating mode. The test mode may additionally, or alternatively, be associated with operation of the interface 117 at a relaxed or slower data rate. For example, after transitioning to the test mode, the memory system 110 may transfer data (e.g., previously written data) from the one or more memory arrays 155 for output to the host system 105 via the data path 116. However, before transmitting the data to the host system 105, the memory system 110 may select a subset of the data for transmission at a relaxed rate by transmitting duplicates of the subset symbols. By doing so, the memory system 110 may allow the data path 116 to run at a maximum or higher data rate than is supported by the interface 117, while also widening symbols of the transmitted data to enable more accurate strobing by the host system 105.

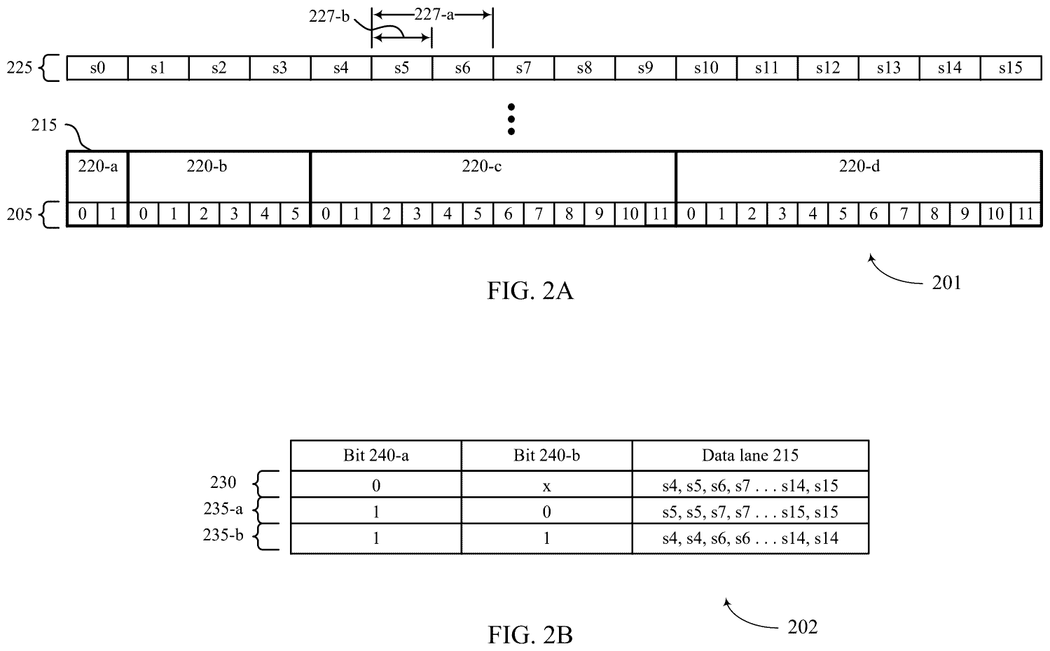

FIG. 2A shows an example of a timing diagram 201 and FIG. 2B shows an example of a mode configuration table 202 that supports interface and data path decoupling in accordance with examples as disclosed herein. One or more aspects of the timing diagram 201 and the mode configuration table 202 may be implemented by one or more aspects of the system 100. For example, the timing diagram 201 may illustrate a bit order for data 205 of a data burst for encoding and transmission from the memory system 110 to the host system 105, which may be performed during a test operation that supports independent data path and interface data rates. In some examples, the data 205 may include one or more bits for communication via a data lane 215 (e.g., DQ lane) at a data pin (e.g., DQ pin) of the memory system 110. The data lane 215 may correspond to a DQ channel (e.g., DQ1, DQ2, up to DQE, or any other DQ channel) of the memory system 110, such as of the channels 115 of the interface 117.

In some examples, the data 205 may be grouped into one or more groups 220 for encoding and transmission, including groups 220-a, 220-b, 220-c, and 220-d. Each group 220 may include one or more bits of the data 205. For example, the group 220-a may include ECC-related bits (e.g., one or more separated and POISON bits, enc_sp), while the group 220-b may include encoded data bits (e.g., enc_data) that may correspond to data bits received via a data channel 115 of the interface 117, or transferred from one or more memory blocks of one or more memory arrays 155. The groups 220-c and 220-d may include CRC data organized into two groups of CRC bits. In some cases, the groups 220-c and 220-d may each have a same quantity, N, of bits. Additionally, or alternatively, there may be some differences in bit quantities between the groups 220-c and 220-d.

With respect to FIG. 2A, the example timing diagram 201 may illustrate 12 bits in each of the groups 220-c and 220-d (e.g., bits 0, 1, 2, 3, 4, 5, 6, 7, 8 . . . 11) while including six bits (e.g., bits 0, 1, 2, 3, 4, 5) and two bits (e.g., bits 0 and 1) for groups 220-b and 220-a, respectively. However, it is to be understood that FIG. 2A is an example, and that any quantity of bits may be included in any quantity of one or more groups 220. In some examples, one or more of the bits may be transferred over parallel lines before encoding for transmission. For example, the bits 0-11 of the group 220-c may be transferred over a first line designated as an even line, and so may be referred to as even CRC bits (e.g., crc_even), while the bits 0-11 of group 220-d may be transferred over a second line designated as an odd line for odd CRC bits (e.g., crc_odd), or vice versa.

The bits may be encoded into one or more symbols of a set of symbols 225 for transmission, where the FIG. 2A may illustrate potential symbol assignments for each bit for a PAM3 modulation scheme. For example, each two consecutive bits may be encoded into a corresponding symbol s, where the bits 0 and 1 of the group 220-a may be encoded into a symbol s0 while the bits 0-5 of the group 220-b may be encoded into symbols s1, s2, and s3. Symbols s4-s9 (s4, s5, s6, s7, s8, s9) may thus correspond to a PAM3 encoding of the bits 0-11 of the group 220-c, while symbols s10-s15 (s10, s11, s12, s13, s14, and s15) may correspond to a PAM3 encoding of the bits 0-11 of the group 220-d. During an operating mode, the memory system 110 may transmit the encoded symbols to the host system 105 via the interface 117 (e.g., via the DQE pin) according to a default data rate for the interface 117, which may be the same as or different than a default operating rate of the data path 116. However, the interface 117 may not support as high of a maximum data rate as may be supported by the data path 116 of the memory system 110 via which the bits may be transferred to an encoder, which may prevent a respective maximum speed for operations at the data path 116 and the interface 117 to be determined.

As discussed herein, the memory system 110 may support decoupling of the data path 116 and the interface 117 during one or more test modes by relaxing a speed of the interface 117. The mode configuration table 202 in FIG. 2B may illustrate different example mode configurations that may be supported by the memory system 110. The supported modes may include an operating mode 230 as well as two test modes 235-a and 235-b. The memory system 110 may receive an indication of the test mode 235-a or the test mode 235-b for the memory system 110, from the host system 105, for operating the interface 117 at a first data rate. The first data rate associated with the test modes 235 may be relaxed compared to a second data rate (e.g., slowed speed compared to default) at which the interface 117 operates during the operating mode 230. When a test mode 235 is enabled and the interface 117 operates at the first data rate, the data path 116 may be operated at the second data rate (e.g., default) or a third data rate (e.g., a maximum or increased data rate, full speed faster than default). In some examples, the indication of the test mode 235 may be received at the memory system controller 140 from the host system controller 120 or via other signaling from the host system 105 or another external device.

Each mode may correspond to (e.g., be activated by) a different combination of bit values 240-a and 240-b, where the bit value 240-a (e.g., tm_crc_hr) may enable or disable test mode functionality, and the bit value 240-b may indicate a specific test mode 235. For example, the operating mode 230 may correspond to the bit value 240-a being ‘0’, where the bit value 240-b may be any value x (0 or 1 or indeterminate). That is, when the bit value 240-a is ‘0’, any test mode may not be enabled. When the bit value 240-a is ‘1’, a test mode may be enabled and the bit value 240-b (e.g., and one or more other bit values, in some cases) may indicate which test mode is enabled. For example, the test mode 235-a may correspond to values [1, 0], while the test mode 235-b may correspond to values [1, 1]. In some examples, the bit values 240-a and 240-b may be included in the indication. For example, the memory system 110 may receive a mode register set (MRS) which may write one or both of the bit values 240-a and 240-b to a mode register (MR) of the memory system 110 that may be read to determine a mode.

The memory system 110 may enter an indicated test mode 235 or may remain in the operating mode 230 based on the indication (e.g., based on the value of the bit values 240-a and 240-b ). If the bit values 240-a and 240-b are [1, 0], the memory system 110 may enter the test mode 235-a. After entering the test mode 235-a, the memory system 110 may transfer first data, such as the even bits of the group 220-c, and second data, such as the odd bits of the group 220-d (e.g., second data), to one or more encoders via the data path 116 according to the second data rate (or the third data rate). After encoding the bits into the symbols s4-s15, the memory system 110 may select, from the first data and the second data and based on the indicated test mode 235-a, data for transmission via the interface 117 according to the first data rate using a relaxed transmission scheme (e.g., a double pass CRC scheme).

For example, based on being in the test mode 235-a, the memory system 110 may select a subset of odd numbered symbols of the set of symbols 225, including symbols s5, s7, s9, s11, s13, and s15 from both of the groups 220-c and 220-d. In such an example, the test mode 235-a may be referred to as an odd test mode, and the odd numbered symbols as well as even numbered symbols (e.g., s4, s6, s8, s10, s12, and s14) may represent alternating symbols of the set of symbols 225. In place of transmitting each of the symbols s4-s15 in order as in the operating mode 230, the memory system 110 may transmit a sequence of symbols of s5, s5, s7, s7 . . . s15, s15 based on the selecting and the test mode 235-a, where each of the duplicate pairs of odd numbered symbols may represent a symbol with a width 227-a that is twice an original width 227-b.

After transmitting the odd symbols, the memory system 110 may receive a second indication to enter the test mode 235-b (e.g., the bit value 240-b, or tm_crc_hr_evensym, may indicate a ‘1’), which may be an example of an even test mode and may be associated with the first data rate. During the test mode 235-b, the memory system 110 may similarly transfer a same set of data as during the test mode 235-a via the data path 116 at the second or third data rate. However, after encoding the set of data, the memory system 110 may select a subset of even numbered symbols including symbols s4, s6, s8, s10, s12, and s14 for transfer via the interface 117 at the first data rate based on the test mode 235-b, and may transmit the subset of even numbered symbols based on the selecting. In some examples, once the host system 105 has received or decoded both subsets of data, or each time a single subset of data is received or decoded, the host system 105 may determine whether the transfer was accurate and whether one or more errors exist.

The memory system 110 may, in some cases, reenter the operating mode 230 after receiving a reset instruction from the host system 105. For example, the reset instruction may reset the bit values 240-a and 240-b may to [0, x]. The reset instruction may be associated with a reset procedure (e.g., a reset of the memory system 110), or an explicit indication (e.g., MRS command). Based on the reset instruction, the memory system 110 may operate in the operating mode by transferring data via the data path 116 according to the second data rate and transmitting both subsets of data according to the second data rate based on the operating mode. In some examples, similar procedures may be performed for transferring data to one or more memory arrays of the memory system 110. For example, the memory system 110 may receive, via the interface 117, both subsets of the set of symbols 225 according to the second data rate based on a current test mode 235. The memory system 110 may select data for transfer to one or more memory arrays 155 as either the odd subset or the even subset of symbols, and may transfer the selected data for transfer to one or more memory arrays 155 via the data path 116 according to the first data rate. In some examples, the transferring the data for transfer to the one or more memory arrays 155 may be part of a write operation, while transferring the data for transmission to the host system 105 may be part of a read operation.

In some examples, the testing procedures described herein may involve a single command in place of the indications where, based on receiving the single command, the memory system 110 may perform data transfer for both even and odd symbols one after the other (e.g., using stored data). Additionally, or alternatively, the test procedures may involve receiving one or more explicit write commands, read commands, or both, for writing and reading the bits after receiving the first indication and the second indication.

The test modes 235-a and 235-b may thereby support a reduced data rate for transmission of data over an interface, while maintaining a higher data rate for transmission of data via internal data paths. By reducing the data rate over the interface, the symbols may be associated with wider symbol durations, which may provide for the host system 105 to strobe (e.g., at a constant voltage at a midpoint of each symbol) the data with increased accuracy as compared with data transmitted at a higher data rate and a decreased symbol width, which may improve a testing accuracy and reliability, providing for improved device performance. Further, by running the interface 117 at half an operating data rate, the memory system 110 may support higher data rates for the data path 116 to perform targeted testing of one or more blocks of the data path 116.

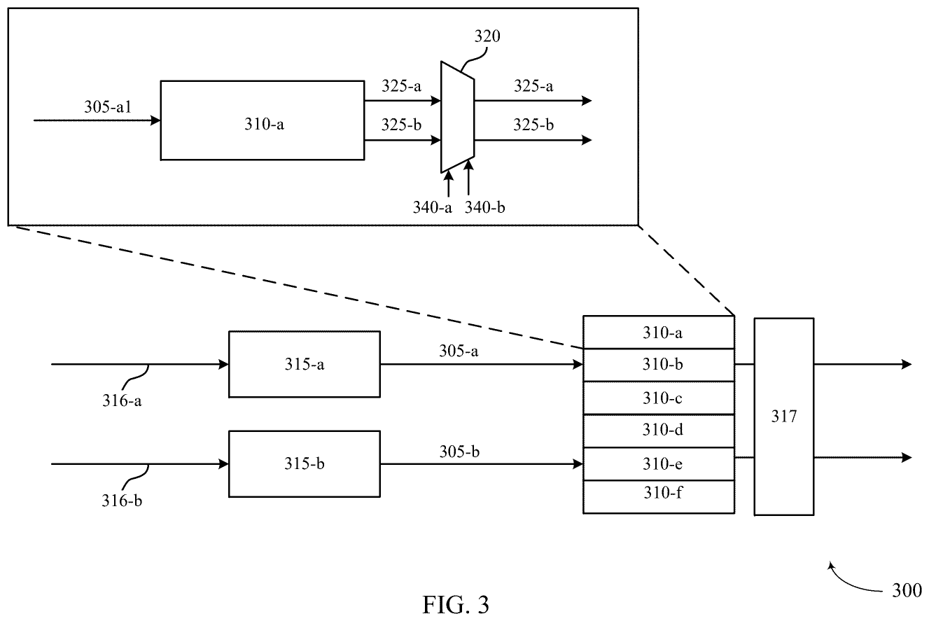

FIG. 3 shows an example of an encoding circuit 300 that supports interface and data path decoupling in accordance with examples as disclosed herein. One or more aspects of the encoding circuit 300 may be implemented by one or more aspects of the system 100, the timing diagram 201, or the mode configuration table 202. For example, the encoding circuit 300 may illustrate circuitry (e.g., one or more circuits) and encoders supporting transmission of parallel data 305 at a reduced data rate during a test mode at the memory system 110 for parallel transmission. In some examples, the encoding circuit 300 may include a data path 316-a and a data path 316-b coupled (directly or indirectly via one or more intermediate components or circuits) with an input of an error detection circuit 315-a and an error detection circuit 315-b, respectively. In some examples, the data path 316-a and 316-b may be referred to as odd and even paths (e.g., lines), respectively, or vice versa, and may be each connected with similar data blocks, or may be connected to respective separate data blocks. An output of the error detection circuits 315-a and 315-b may each be coupled (directly or indirectly) with an input of one or more first encoders 310 (e.g., encoders 310-a, 310-b, and 310-c) while the error detection circuit 315-b may be coupled with an input of one or more second encoders 310 (e.g., encoders 310-d, 310-e, and 310-f).

In some examples, the error detection circuits 315-a and 315-b may be configured to output a quantity of CRC bits (e.g., eight bits, a byte) based on one or more data bits. For example, based on receiving prior data 305 transferred via the data paths 316-a and 316-b (which may be configured to convey data 305), the error detection circuits 315-a and 315-b may generate and output data 305-a and 305-b to an input of the encoders 310, which may represent one or more CRC bits of the groups 220-c and 220-c of FIG. 2A. The encoders 310 may be configured to encode the data 305 according to PAM3 or other multi-level coding schemes (e.g., modulation coding schemes), and may be part of a same encoder or may be separate encoding devices.

In some examples, each encoder 310 in the encoding circuit 300 may include a respective multiplexing (MUX) circuit 320 coupled with an output of the encoder 310. The MUX circuit 320 may be operable to select a set of encoded data to output via an interface 317 (e.g., the interface 117). The selected set of encoded data may include odd numbered symbols (e.g., odd symbols), even numbered symbols (e.g., even symbols), or both, for transmission. For example, the MUX circuit 320 may be coupled with one or more outputs of the encoder 310-a, which may receive a first subset of data 305-a1 (e.g., a subset of the data 305-a), and may output one or more odd symbols 325-a and one or more even symbols 325-b (e.g., PAM3). In some examples, the encoder 310-a may be configured to output odd symbols 325-a and even symbols 325-b via separate data paths, and each data path may be coupled with a respective input of the MUX circuit 320, which may enable the MUX circuit 320 to select one or the other during a test mode.

In some examples, a bit value 340-a and a bit value 340-b may determine a set of encoded data selected by the MUX circuit 320. For example, the bit value 340-a may represent the bit value 240-a described with reference to FIG. 2B, and may determine whether the memory system 110 is in an operating mode or whether one or more test modes are enabled, while the bit value 340-b may represent the bit value 240-b described with reference to FIG. 2B and may indicate a specific test mode selected from among two candidate test modes. In some examples, the bit values 340-a and 340-b may represent values of an MR of the memory system 110 that is coupled with the MUX circuit 320 to enable and select a mode for transmission. Based on a mode of the memory system 110, the MUX circuit 320 may select one or both of even and odd symbols for transmission. For example, during an operating mode, half-rate CRC transmission using a subset of symbols may be disabled based on the bit value 340-a having a value of ‘0’, where both even and odd symbols 325 may be transmitted (e.g., via the MUX circuit 320 that may transmit both during the operating mode, or via alternate lines if the MUX circuit 320 is disabled by the bit value 340-a of ‘0’). However, during an odd test mode, the MUX circuit 320 may limit output to transmit the odd symbols 325-a based on the bit value 340-a and the bit value 340-b indicating [1, 0]. Similarly, during an even test mode, the MUX circuit 320 may output the even symbols 325-b based on the bit values 340-a and 340-b indicating [1, 1].

In some cases, the MUX circuit 320 may be coupled with an interface 317, which may be configured to convey the selected symbols according to a slower data rate during a test mode. For example, the selected symbols may be duplicated such that two or more repeated versions of each symbol are transmitted via the interface 317, thereby increasing (e.g., doubling, tripling, etc.) a duration of each symbol and decreasing the data rate. In some examples, the MUX circuit 320 and other components of the encoding circuit 300 may be in other configurations for bit selection and separation for transmission. Further, a data rate at the interface 317 may be slowed or lowered using one or more different methods. In some examples, although the methods described herein lower a data rate of the interface 317, the data rates of the data path 116 may be less than or equal to the data rate of the interface 317 during one or more test modes or operating modes, where similar operations may be performed to support higher interface data rates. Various different subsets may also be selected for transfer. For example, the memory system 110 may determine to transfer data of the data path 316-a while refraining from transferring data of the data path 316-b during a single test mode (e.g., to compare data paths for different blocks). In such an example, the odd symbols 325-a and the even symbols 325-b may represent symbols corresponding to the data path 316-a and the data path 316-b, respectively. Further, while the encoding circuit 300 may illustrate the error detection circuits 315 coupled between the data paths 316 and the encoders 310, the data paths 316 may in some cases be coupled directly to an input of the encoders 310. The encoding circuit 300 may also include or exclude any of the components and circuits described and illustrated, which also may be connected in different configurations. In some cases, the terms “first” and “second” with reference to one or more objects, unless otherwise stated, may be interpreted as at least partially different.

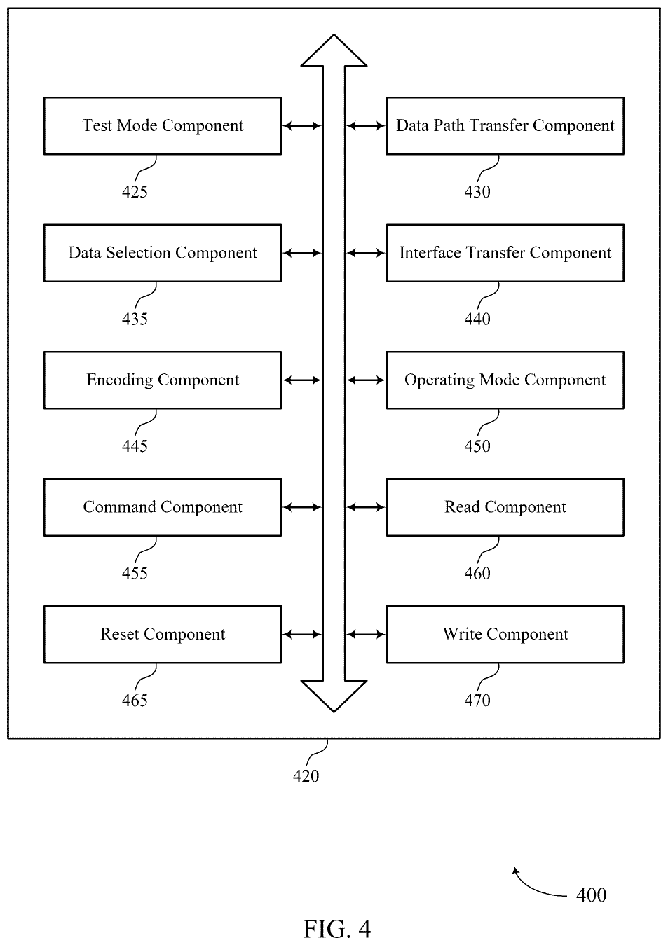

FIG. 4 shows a block diagram 400 of a memory system 420 that supports interface and data path decoupling in accordance with examples as disclosed herein. The memory system 420 may be an example of aspects of a memory system as described with reference to FIGS. 1 through 3. The memory system 420, or various components thereof, may be an example of means for performing various aspects of interface and data path decoupling as described herein. For example, the memory system 420 may include a test mode component 425, a data path transfer component 430, a data selection component 435, an interface transfer component 440, an encoding component 445, an operating mode component 450, a command component 455, a read component 460, a reset component 465, a write component 470, or any combination thereof. Each of these components, or components of subcomponents thereof (e.g., one or more processors, one or more memories), may communicate, directly or indirectly, with one another (e.g., via one or more buses).

The test mode component 425 may be configured as or otherwise support a means for receiving an indication of a test mode for a memory system, the test mode associated with a first data rate for an interface of the memory system. The data path transfer component 430 may be configured as or otherwise support a means for transferring, from a memory array and via a data path of the memory system, first data and second data according to a second data rate. The data selection component 435 may be configured as or otherwise support a means for selecting, from the first data and the second data based at least in part on the test mode, data for transmission via the interface. The interface transfer component 440 may be configured as or otherwise support a means for transmitting, via the interface and based at least in part on the selecting, the data according to the first data rate.

In some examples, to support selecting the data, the data selection component 435 may be configured as or otherwise support a means for selecting the first data based at least in part on the test mode for the memory system, where the second data is associated with a second test mode for the memory system.

In some examples, the test mode component 425 may be configured as or otherwise support a means for receiving, after selecting the first data, a second indication of the second test mode for the memory system, the second test mode associated with the first data rate for the interface. In some examples, the data selection component 435 may be configured as or otherwise support a means for selecting, from the first data and the second data based at least in part on the second test mode, the second data for transmission via the interface. In some examples, the interface transfer component 440 may be configured as or otherwise support a means for transmitting, via the interface and based at least in part on the selecting, the second data according to the first data rate.

In some examples, the encoding component 445 may be configured as or otherwise support a means for encoding the first data and the second data according to a multi-level coding scheme, where the data includes either the first data or the second data after the encoding.

In some examples, the operating mode component 450 may be configured as or otherwise support a means for operating in an operating mode for the memory system. In some examples, the data path transfer component 430 may be configured as or otherwise support a means for transferring, from the memory array and via the data path, a third data and a fourth data according to the second data rate. In some examples, the interface transfer component 440 may be configured as or otherwise support a means for transmitting, via the interface, the third data and the fourth data according to the second data rate based at least in part on the operating mode.

In some examples, the reset component 465 may be configured as or otherwise support a means for receiving a reset instruction for the memory system, where operating in the operating mode is based at least in part on the reset instruction.

In some examples, the interface transfer component 440 may be configured as or otherwise support a means for receiving, via the interface, a third data and a fourth data according to the second data rate based at least in part on the test mode. In some examples, the data selection component 435 may be configured as or otherwise support a means for selecting, from the third data and the fourth data based at least in part on the test mode, data for transfer to the memory array. In some examples, the data path transfer component 430 may be configured as or otherwise support a means for transferring, to the memory array and via the data path according to the first data rate, the data for transfer.

In some examples, the command component 455 may be configured as or otherwise support a means for receiving, from a host device, a write command to write the third data and the fourth data, where receiving the third data and the fourth data via the interface is based at least in part on the write command. In some examples, the write component 470 may be configured as or otherwise support a means for writing the second data to the memory array based at least in part on the write command and transferring the second data via the data path.

In some examples, the command component 455 may be configured as or otherwise support a means for receiving, from a host device, a read command to read the first data and the second data. In some examples, the read component 460 may be configured as or otherwise support a means for reading the first data and the second data from the memory array based at least in part on the read command, where the data is transmitted to the host device via the interface based at least in part on the read command.

In some examples, the test mode is associated with one of a set of even symbols or a set of odd symbols and a second test mode for the memory system is associated with the other of the set of even symbols or the set of odd symbols.

In some examples, the first data and the second data include cyclic redundancy check data.

In some examples, the second data rate is greater than the first data rate based at least in part on the selecting and the test mode.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

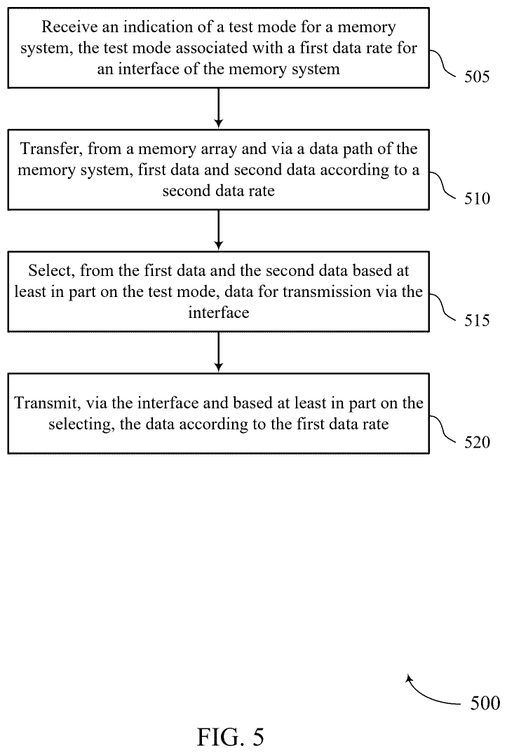

FIG. 5 shows a flowchart illustrating a method 500 that supports interface and data path decoupling in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving an indication of a test mode for a memory system, the test mode associated with a first data rate for an interface of the memory system. In some examples, aspects of the operations of 505 may be performed by a test mode component 425 as described with reference to FIG. 4.

At 510, the method may include transferring, from a memory array and via a data path of the memory system, first data and second data according to a second data rate. In some examples, aspects of the operations of 510 may be performed by a data path transfer component 430 as described with reference to FIG. 4.

At 515, the method may include selecting, from the first data and the second data based at least in part on the test mode, data for transmission via the interface. In some examples, aspects of the operations of 515 may be performed by a data selection component 435 as described with reference to FIG. 4.

At 520, the method may include transmitting, via the interface and based at least in part on the selecting, the data according to the first data rate. In some examples, aspects of the operations of 520 may be performed by an interface transfer component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving an indication of a test mode for a memory system, the test mode associated with a first data rate for an interface of the memory system; transferring, from a memory array and via a data path of the memory system, first data and second data according to a second data rate; selecting, from the first data and the second data based at least in part on the test mode, data for transmission via the interface; and transmitting, via the interface and based at least in part on the selecting, the data according to the first data rate.

Aspect 2: The method, apparatus, or non-transitory computer-readable medium of aspect 1, where selecting the data includes operations, features, circuitry, logic, means, or instructions, or any combination thereof for selecting the first data based at least in part on the test mode for the memory system, where the second data is associated with a second test mode for the memory system.

Aspect 3: The method, apparatus, or non-transitory computer-readable medium of aspect 2, further including operations, features, circuitry, logic, means, or instructions, or any combination thereof for receiving, after selecting the first data, a second indication of the second test mode for the memory system, the second test mode associated with the first data rate for the interface; selecting, from the first data and the second data based at least in part on the second test mode, the second data for transmission via the interface; and transmitting, via the interface and based at least in part on the selecting, the second data according to the first data rate.

Aspect 4: The method, apparatus, or non-transitory computer-readable medium of any of aspects 1 through 3, further including operations, features, circuitry, logic, means, or instructions, or any combination thereof for encoding the first data and the second data according to a multi-level coding scheme, where the data includes either the first data or the second data after the encoding.

Aspect 5: The method, apparatus, or non-transitory computer-readable medium of any of aspects 1 through 4, further including operations, features, circuitry, logic, means, or instructions, or any combination thereof for operating in an operating mode for the memory system; transferring, from the memory array and via the data path, a third data and a fourth data according to the second data rate; and transmitting, via the interface, the third data and the fourth data according to the second data rate based at least in part on the operating mode.

Aspect 6: The method, apparatus, or non-transitory computer-readable medium of aspect 5, further including operations, features, circuitry, logic, means, or instructions, or any combination thereof for receiving a reset instruction for the memory system, where operating in the operating mode is based at least in part on the reset instruction.

Aspect 7: The method, apparatus, or non-transitory computer-readable medium of any of aspects 1 through 6, further including operations, features, circuitry, logic, means, or instructions, or any combination thereof for receiving, via the interface, a third data and a fourth data according to the second data rate based at least in part on the test mode; selecting, from the third data and the fourth data based at least in part on the test mode, data for transfer to the memory array; and transferring, to the memory array and via the data path according to the first data rate, the data for transfer.

Aspect 8: The method, apparatus, or non-transitory computer-readable medium of aspect 7, further including operations, features, circuitry, logic, means, or instructions, or any combination thereof for receiving, from a host device, a write command to write the third data and the fourth data, where receiving the third data and the fourth data via the interface is based at least in part on the write command and writing the second data to the memory array based at least in part on the write command and transferring the second data via the data path.

Aspect 9: The method, apparatus, or non-transitory computer-readable medium of any of aspects 1 through 8, further including operations, features, circuitry, logic, means, or instructions, or any combination thereof for receiving, from a host device, a read command to read the first data and the second data and reading the first data and the second data from the memory array based at least in part on the read command, where the data is transmitted to the host device via the interface based at least in part on the read command.

Aspect 10: The method, apparatus, or non-transitory computer-readable medium of any of aspects 1 through 9, where the test mode is associated with one of a set of even symbols or a set of odd symbols and a second test mode for the memory system is associated with the other of the set of even symbols or the set of odd symbols.

Aspect 11: The method, apparatus, or non-transitory computer-readable medium of any of aspects 1 through 10, where the first data and the second data include cyclic redundancy check data.

Aspect 12: The method, apparatus, or non-transitory computer-readable medium of any of aspects 1 through 11, where the second data rate is greater than the first data rate based at least in part on the selecting and the test mode.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 13: A memory system, including: one or more data paths including a first data path configured to convey first data according to a first data rate and a second data path configured to convey second data according to the first data rate; one or more encoders configured to encode the first data and the second data according to a multi-level coding scheme; multiplexing circuitry coupled with an output of the one or more encoders, the multiplexing circuitry configured to select, based at least in part on a test mode for the memory system, a set of encoded data for transmission, the set of encoded data based at least in part on the first data, the second data, or both; and an interface coupled with the multiplexing circuitry and configured to convey the selected set of encoded data according to a second data rate based at least in part on the test mode for the memory system.

Aspect 14: The memory system of aspect 13, further including: error detection circuitry coupled with an input of the one or more encoders, where the error detection circuitry is configured to output a first set of error detecting codes based at least in part on the first data conveyed via the first data path, and a second set of error detecting codes based at least in part on the second data conveyed via the second data path.

Aspect 15: The memory system of any of aspects 13 through 14, where the multiplexing circuitry is configured to select the set of encoded data based at least in part on a first bit value enabling the test mode and a second bit value corresponding to one of two different test modes.

Aspect 16: The memory system of any of aspects 13 through 15, where the multi-level coding scheme includes an amplitude modulation scheme including three amplitude modulation levels.

Aspect 17: The memory system of any of aspects 13 through 16, where the first data and the second data are transmitted in parallel via the first data path and the second data path, respectively.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive an indication of a test mode for a memory system, the test mode associated with a first data rate for an interface of the memory system;
transfer, from a memory array and via a data path of the memory system, first data and second data according to a second data rate;
select, from the first data and the second data based at least in part on the test mode, data for transmission via the interface; and
transmit, via the interface and based at least in part on the selecting, the data according to the first data rate.

2. The memory system of claim 1, wherein, to select the data, the processing circuitry is configured to cause the memory system to:
select the first data based at least in part on the test mode for the memory system, wherein the second data is associated with a second test mode for the memory system.

3. The memory system of claim 2, wherein the processing circuitry is further configured to cause the memory system to:
receive, after selecting the first data, a second indication of the second test mode for the memory system, the second test mode associated with the first data rate for the interface;
select, from the first data and the second data based at least in part on the second test mode, the second data for transmission via the interface; and
transmit, via the interface and based at least in part on the selecting, the second data according to the first data rate.

4. The memory system of claim 1, the processing circuitry is further configured to cause the memory system to:
encode the first data and the second data according to a multi-level coding scheme, wherein the data comprises either the first data or the second data after the encoding.

5. The memory system of claim 1, wherein the processing circuitry is further configured to cause the memory system to:
operate in an operating mode for the memory system;
transfer, from the memory array and via the data path, a third data and a fourth data according to the second data rate; and
transmit, via the interface, the third data and the fourth data according to the second data rate based at least in part on the operating mode.

6. The memory system of claim 5, wherein the processing circuitry is further configured to cause the memory system to:
receive a reset instruction for the memory system, wherein operating in the operating mode is based at least in part on the reset instruction.

7. The memory system of claim 1, wherein the processing circuitry is further configured to cause the memory system to:
receive, via the interface, a third data and a fourth data according to the second data rate based at least in part on the test mode;
select, from the third data and the fourth data based at least in part on the test mode, data for transfer to the memory array; and
transfer, to the memory array and via the data path according to the first data rate, the data for transfer.

8. The memory system of claim 7, wherein the processing circuitry is further configured to cause the memory system to:
receive, from a host device, a write command to write the third data and the fourth data, wherein receiving the third data and the fourth data via the interface is based at least in part on the write command; and
write the second data to the memory array based at least in part on the write command and transferring the second data via the data path.

9. The memory system of claim 1, wherein the processing circuitry is further configured to cause the memory system to:
receive, from a host device, a read command to read the first data and the second data; and
read the first data and the second data from the memory array based at least in part on the read command, wherein the data is transmitted to the host device via the interface based at least in part on the read command.

10. The memory system of claim 1, wherein:
the test mode is associated with one of a set of even symbols or a set of odd symbols; and
a second test mode for the memory system is associated with the other of the set of even symbols or the set of odd symbols.

11. The memory system of claim 1, wherein the first data and the second data comprise cyclic redundancy check data.

12. The memory system of claim 1, wherein the second data rate is greater than the first data rate based at least in part on the selecting and the test mode.

13. A memory system, comprising:
one or more data paths comprising a first data path configured to convey first data according to a first data rate and a second data path configured to convey second data according to the first data rate;
one or more encoders configured to encode the first data and the second data according to a multi-level coding scheme;
multiplexing circuitry coupled with an output of the one or more encoders, the multiplexing circuitry configured to select, based at least in part on a test mode for the memory system, a set of encoded data for transmission, the set of encoded data based at least in part on the first data, the second data, or both; and
an interface coupled with the multiplexing circuitry and configured to convey the selected set of encoded data according to a second data rate based at least in part on the test mode for the memory system.

14. The memory system of claim 13, further comprising:
error detection circuitry coupled with an input of the one or more encoders, wherein the error detection circuitry is configured to output a first set of error detecting codes based at least in part on the first data conveyed via the first data path, and a second set of error detecting codes based at least in part on the second data conveyed via the second data path.

15. The memory system of claim 13, wherein the multiplexing circuitry is configured to select the set of encoded data based at least in part on a first bit value enabling the test mode and a second bit value corresponding to one of two different test modes.

16. The memory system of claim 13, wherein the multi-level coding scheme comprises an amplitude modulation scheme comprising three amplitude modulation levels.

17. The memory system of claim 13, wherein the first data and the second data are transmitted in parallel via the first data path and the second data path, respectively.

18. A method by a memory system, comprising:
receiving an indication of a test mode for a memory system, the test mode associated with a first data rate for an interface of the memory system;
transferring, from a memory array and via a data path of the memory system, first data and second data according to a second data rate;
selecting, from the first data and the second data based at least in part on the test mode, data for transmission via the interface; and
transmitting, via the interface and based at least in part on the selecting, the data according to the first data rate.

19. The method of claim 18, wherein selecting data comprises:
selecting the first data based at least in part on the test mode for the memory system, wherein the second data is associated with a second test mode for the memory system.

20. The method of claim 19, further comprising:
receiving, after selecting the first data, a second indication of the second test mode for the memory system, the second test mode associated with the first data rate for the interface;
selecting, from the first data and the second data based at least in part on the second test mode, the second data for transmission via the interface; and
transmitting, via the interface and based at least in part on the selecting, the second data according to the first data rate.
